(19) United States
(12) Patent Application Publication
(10) Pub. No.: US 2006/0086575 A1
(43) Pub. Date: Apr. 27, 2006

(54) Lever assembly for a vehicle brake and method of assembly therefor

(76) Inventor: Keith James Niehorster, Swansea (GB)

Correspondence Address: CARLSON, GASKEY & OLDS, P.C., 400 WEST MAPLE ROAD, SUITE 350, BIRMINGHAM, MI, 48009, US

(21) Appl. No.: 11/248,007

(22) Filed: Oct. 11, 2005

(30) Foreign Application Priority Data
Oct. 25, 2004 (EP) 04256574.7

(51) Int. Cl. F16D 55/02

(52) U.S. Cl. 188/71.9

(57) ABSTRACT

A lever assembly for a vehicle brake includes an operating shaft having a lever aperture, a lever engageable with the lever aperture and a retainer pin insertable into the lever assembly to retain the lever in the lever aperture.

### REFERENCE TO RELATED APPLICATION

This application claims priority to European Patent Application EP 04256574.7 filed on Oct. 25, 2004.

### BACKGROUND OF THE INVENTION

The present invention relates generally to a vehicle brake assembly and more particularly to a lever assembly for actuating a brake and a method of assembling the vehicle brake assembly.

Disc brake assemblies typically include a disc brake caliper that houses one or more pistons for forcing a friction element or brake pad into engagement with one face of a rotor. In disc brakes of the sliding caliper type, the caliper slides relative to the rotor to bring a second friction element facing an opposite face of the rotor into contact with the rotor. Heavy-duty vehicle brake assemblies commonly include multiple pistons that are actuated by a pneumatic actuator via an eccentric cam arrangement. The heavy-duty brake assemblies may be relatively complicated compared to passenger vehicle brake assemblies and may be specifically tailored to particular heavy vehicle applications.

Brakes manufactured on a single line may require different components to be assembled to meet the demands of different applications. This can prove problematic with known brakes, as the parts required to meet the various demands may be high, thereby increasing overall manufacturing costs.

The present invention seeks to overcome, or at least mitigate, the problems of the prior art.

### SUMMARY OF THE INVENTION

Accordingly, one aspect of the present invention provides a lever assembly for a vehicle brake including an operating shaft having a lever aperture, a lever engageable with the lever aperture and a retainer pin insertable into the brake assembly to retain the lever in the lever aperture.

A second aspect of the present invention provides a method of assembling a lever assembly into a vehicle brake housing including the steps of assembling an operating shaft having a lever aperture into a brake housing through a first opening, passing a lever through a second opening in the brake housing into the lever aperture and inserting a retainer pin into the lever assembly to retain the lever in the lever aperture.

### BRIEF DESCRIPTION OF THE DRAWINGS

Embodiments of the present invention will now be described with reference to the accompanying drawings, in which:

FIG. 1 is a cross-sectional end view of a vehicle brake assembly of the present invention;

FIG. 2 is a partially cross-sectional top elevational view of the vehicle brake assembly of the present invention;

FIG. 3 is a side elevation of a housing portion of a caliper part of the vehicle brake assembly of FIG. 1 during assembly thereof;

FIG. 4 is a cross-section view on the plane E-E of FIG. 3;

FIG. 5 is a side elevation of a partially assembled lever assembly of the present invention;

FIG. 6 is a cross-sectional view on the plane G-G of FIG. 5;

FIG. 7 is an enlarged view of section H of FIG. 6; and

FIG. 8 is a perspective view of the fully assembled lever of the present invention.

### DETAILED DESCRIPTION OF THE PREFERRED EMBODIMENT

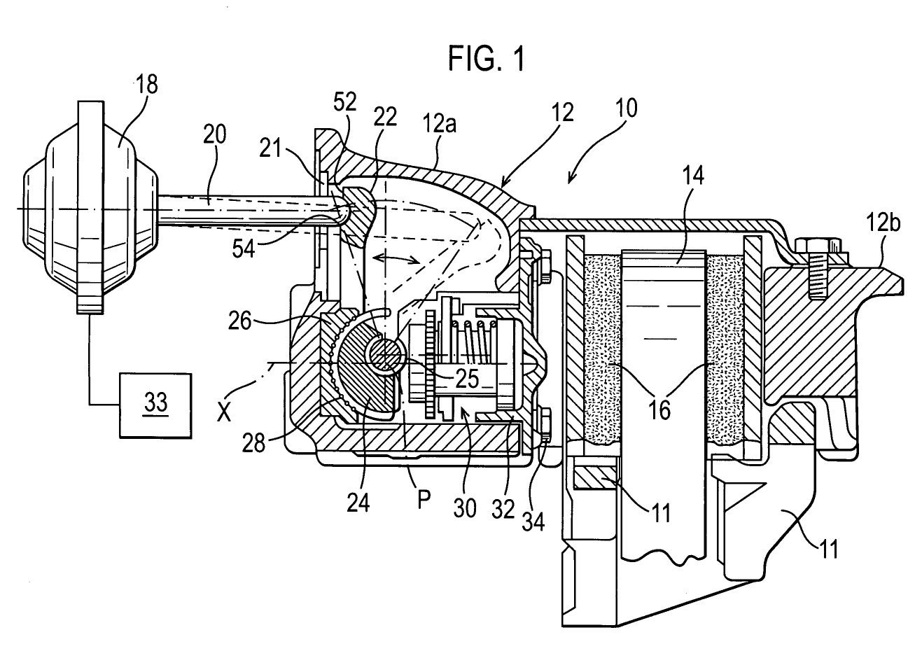

FIG. 1 illustrates a general sectional view of a vehicle brake assembly 10. The vehicle brake assembly 10 includes a caliper 12 that may be constructed from one or more portions. A bridge portion 12b of the caliper 12 straddles a rotor 14 and includes brake pads 16, or friction elements, arranged on either side of the planar surfaces of the rotor 14. The caliper 12 further includes a housing portion 12a. The housing portion 12a and the bridge portion 12b are formed from separate pieces in this embodiment. In other embodiments, the two portions may be integral. The entire caliper 12 is able to slide parallel to an axis X on a carrier 11. The carrier 11 further provides support for the brake pads 16 in a circumferential and radially inwards direction.

An actuator 18 (illustrated schematically), typically an air chamber, actuates a brake mechanism 30 to directly force one brake pad 16 into engagement with the rotor 14. The other brake pad 16 is brought into contact with the rotor 14 due to the sliding action of the caliper 12 relative to the rotor 14. The actuator 18 drives a push rod 20 through a push rod opening 21 to rotate a lever assembly 22 about a pivot point P. The lever assembly 22 includes an eccentric cam 24 having a profile 25 that cooperates with the brake mechanism 30 to drive the brake pads 16. The cam 24 amplifies the force supplied by the actuator 18 when it is transmitted via the brake mechanism 30 to the brake pads 16. The cam 24 is preferably received at least partially within a bearing block 26 supporting a plurality of needle bearings 28 within the housing portion 12a. It should be understood that various actuating systems which are operated by a lever will benefit from the present invention.

A housing opening 31 (shown in FIG. 4) of the housing portion 12a, which receives the brake mechanism 30, is closed off on a front side. That is, the housing opening 31 is closed off, in the position facing the brake rotor 14, by a closing plate 32 which preferably at least partially supports the brake mechanism 30. The closing plate 32 is attached to the housing portion 12a by fasteners, such as bolts 34 or the like. Sealing elements (not shown) are preferably located upon the sealing surfaces between the closing plate 32 and the housing portion 12a.

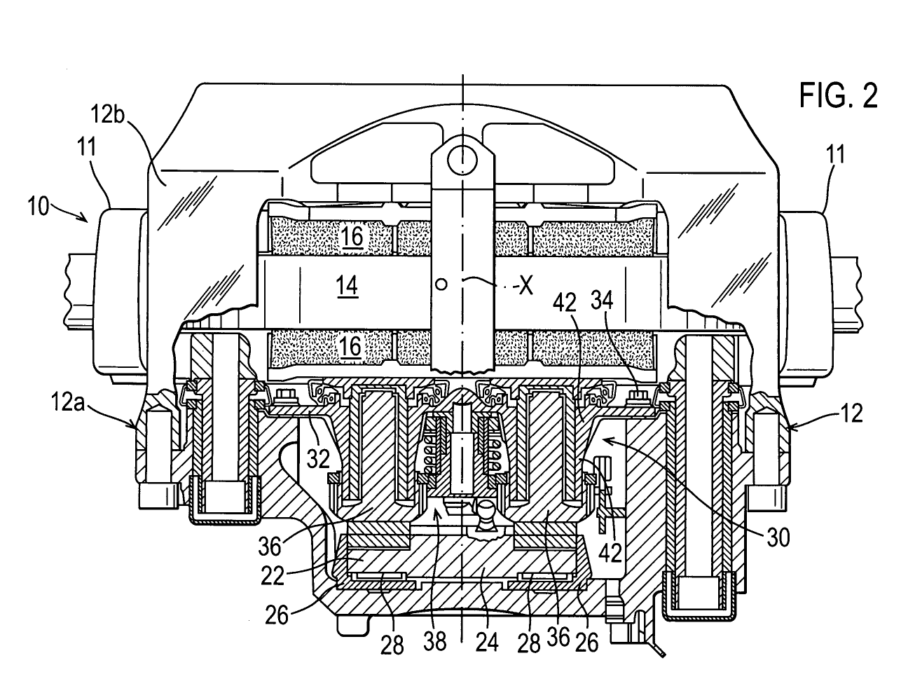

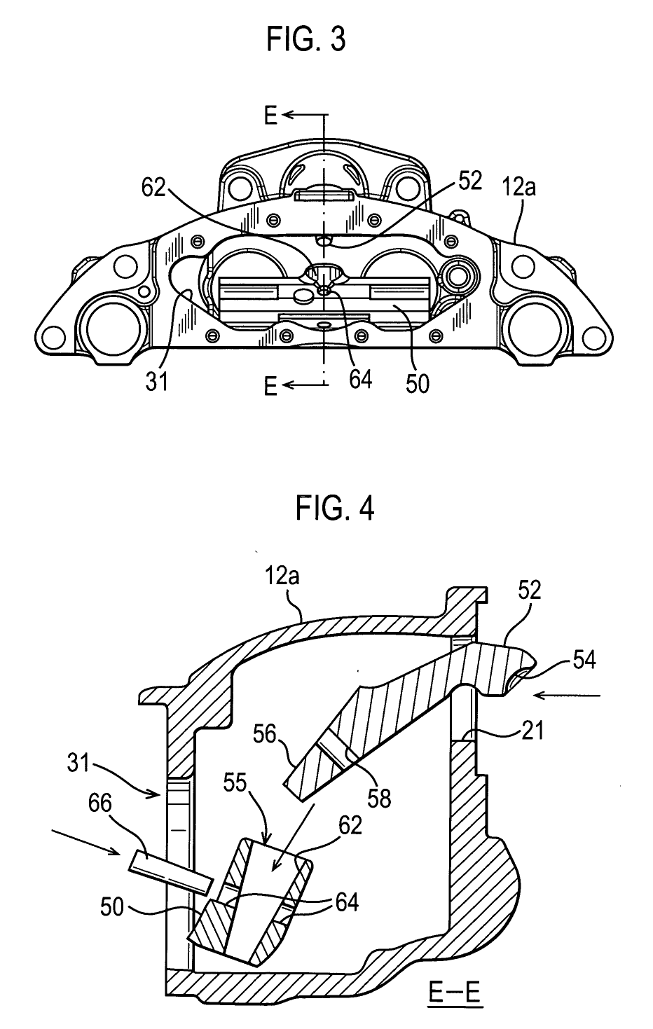

In operation, upon actuation of the brake pedal by the vehicle operator, a pneumatic output is typically produced by a control module 33 to energize the actuator 18. Heavy-duty vehicle brake assemblies typically include the brake mechanism 30 that includes a pair of pistons 36 (shown in FIG. 2) that transmit the force generated by the actuator 18 through the push rod 20 and the lever assembly 22 to the brake pads 16. The brake pads 16 effectively clamp against opposite faces of the rotor 14 and generate frictional drag forces to retard rotation of the rotor 14, and hence the wheel with which it is associated. It is to be understood that any suitable number of pistons 36 may be used.

As the friction material of the brake pads 16 wears, the rest position of the brake pads 16 is adjusted by an adjuster mechanism 38 positioned between the pistons 36 to provide the correct running clearance for the brake. The operation of such mechanisms is well known in the art, and does not form part of the present invention.

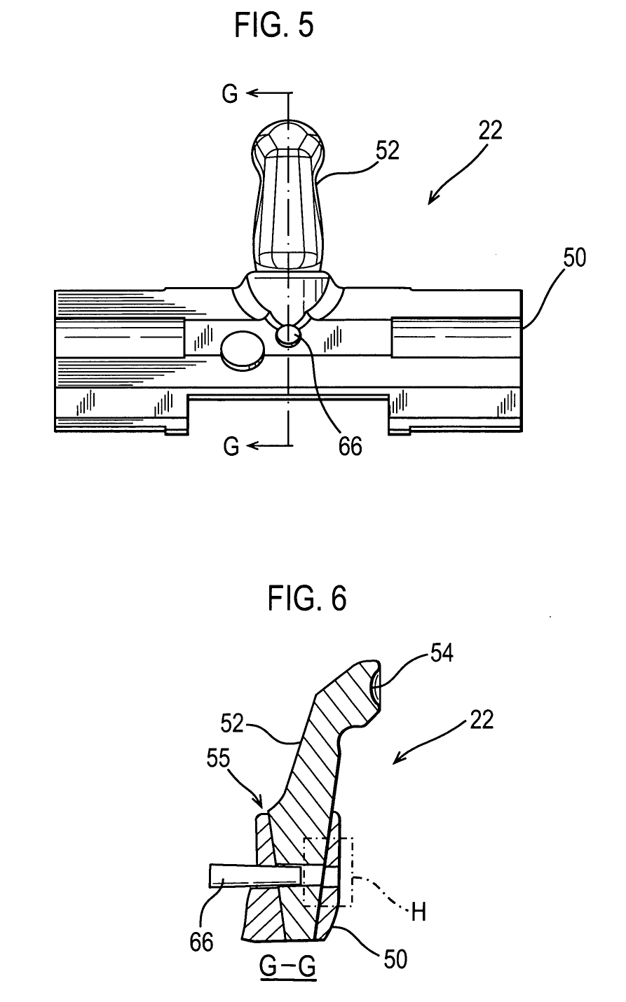

Referring to FIGS. 5, 6 and 8, the lever assembly 22 includes an operating shaft 50 and a lever 52 mounted to the operating shaft 50. The operating shaft 50 includes the cams 24. It should be understood that various operating shaft 50 profiles will benefit from the present invention. The operating shaft 50 further includes a tapered lever aperture 62 arranged transverse an axis of rotation P of the operating shaft 50 on the cams 24. A tapering bore 64 extends through the walls of the lever aperture 62 substantially at right angles thereto.

The lever 52 includes a cupped segment 54 for receiving the push rod 20 (shown in FIG. 1). It should be understood that levers of a specific design, such as a desired length specific to a particular vehicle brake assembly 10, may be interchangeably assembled to a common operating shaft 50 according to the present invention. Likewise, operating shafts of a design specific to a particular vehicle brake assembly 10 may be interchangeably assembled with a common lever according to the present invention.

A taper pin portion 56 and a transverse bore 58 are formed directly into the lever 52. That is, the lever 52 is preferably manufactured from a single piece of material to provide high strength. The lever 52 may also be manufactured of a material different than the operating shaft 50 to further increase the strength thereof.

An interface between the lever aperture 62 of the operating shaft 50 and the taper pin portion 56 of the lever 52 includes an orientation feature 55, such that the lever 52 can only be mounted to the operating shaft 50 in a proper orientation. In other words, the cupped segment 54 for receiving the push rod 20 is properly located. The orientation feature 55 in this embodiment is provided by making the taper pin portion 56 and the lever aperture 62 oval in cross-section, rather than circular. In other embodiments, a key and slot arrangement could alternatively be used, for example.

Referring to FIG. 4, an assembly sequence for the lever assembly 22 is illustrated. The operating shaft 50 is assembled into the housing portion 12a such that the lever aperture 62 is generally orientated towards the push rod opening 21. The lever 52 is passed through the push rod opening 21 and into the lever aperture 62.

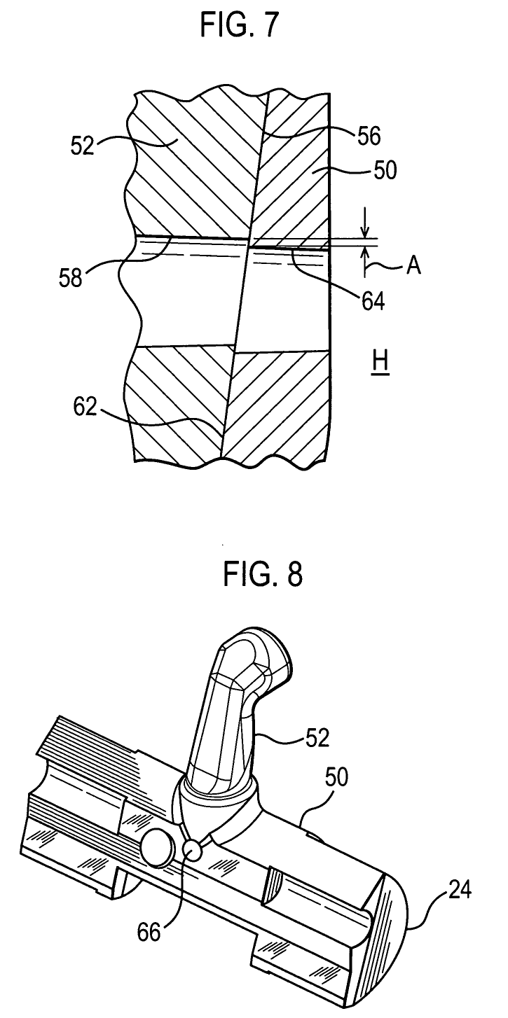

Then, with particular reference to FIGS. 4, 6 and 7, a tapering retainer pin 66 is inserted into the tapering bore 64 from the housing opening 31. When hand fitted together, an offset A exists between the bores 58 and 64. The offset A value may vary depending upon the degree of tapering and materials from which the components are manufactured, but the offset A is typically between 0.2 and 1 mm, preferably 0.5 mm. As the retainer pin 66 is forced home, the offset A is reduced or removed, and a secure connection between the lever 52 and operating shaft 50 is created, as shown in FIG. 8.

The brake mechanism 30, the closing plate 32, the housing portion 12a and the bridge portion 12b may then be assembled together. In its assembled state, the retainer pin 66 does not interfere with operation of the brake mechanism 30 or the adjuster mechanism 38.

By utilizing a two-piece lever assembly, the needs of particular heavy vehicle applications can be met with a minimal number of interchangeable operating shaft and lever portions, rather than multiple complete lever assemblies, thus minimizing the number of separate component castings needed and inventory to be carried.

In particular, the invention may be employed in differing types of brakes, such as fixed caliper, sliding rotor brakes. An additional aperture may be provided in the underside of the brake housing specifically for the insertion of the lever, rather than assembling it through the lever aperture. Furthermore, an aperture may be provided in the rear of the housing to allow the retainer pin to be inserted to secure the lever to the operating shaft after the brake mechanism has been fitted to the housing. In turn, this would permit the lever to be inserted into the lever aperture in the final stages of brake assembly. It will, of course, be apparent that, in the variant, the bores in which the retainer pin fit would taper in the opposite direction. The retainer pin may be provided with some means to ensure its positive securement in the complementary bores. For example, the thinnest end of the pin may be threaded such that a nut and washer can be secured to the pin to hold it in the required position. The nut could also be used to draw the pin through the bore, as an alternative to driving the pin home.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described.

What is claimed is:

1. A lever assembly for a vehicle brake comprising:
an operating shaft including a lever aperture;
a lever engageable with the lever aperture; and
a retainer pin insertable into the lever assembly to retain the lever in the lever aperture.

2. The lever assembly as recited in claim 1, wherein the lever aperture is tapered and the lever includes a corresponding taper pin portion.

3. The lever assembly as recited in claim 1, wherein the operating shaft includes a first bore and the lever includes a second bore, and the retainer pin is insertable into the first bore and the second bore.

4. The lever assembly as recited in claim 3, wherein the first bore and the second bore are axially offset when fitted together and are substantially axially aligned when the retainer pin is driven home.

5. The lever assembly as recited in claim 3, wherein the retainer pin, the first bore and the second bore are tapered.

6. The lever assembly as recited in claim 4, wherein the retainer pin, the first bore and the second bore are tapered.

7. The lever assembly as recited in claim 1, further including an anti-rotation feature between the lever and the operating shaft.

8. A brake caliper incorporating a lever assembly comprising:
an operating shaft including a lever aperture;
a lever engageable with the lever aperture; and
a retainer pin insertable into the lever assembly to retain the lever in the lever aperture.

9. A method of assembling a lever assembly into a vehicle brake housing comprising the steps of:
assembling an operating shaft including a lever aperture through a first opening in the vehicle brake housing;
passing a lever through a second opening in the vehicle brake housing and into the lever aperture; and
inserting a retainer pin into the lever assembly to retain the lever in the lever aperture.

10. The method as recited in claim 9, wherein the second opening is a push rod opening.

11. The method as recited in claim 9, wherein the step of inserting the retainer pin includes driving the retainer pin home to retain the lever in the lever aperture.
